(19) United States
(12) Patent Application Publication
(10) Pub. No.: US 2026/0155117 A1
(43) Pub. Date: Jun. 4, 2026

(54) UNIVERSAL FINGERBOARD FOR STRINGED MUSICAL INSTRUMENT

(71) Applicant: INEEDTHIS, LLC, Sarasota, FL (US)

(72) Inventor: Michael Cloutier, Venice, FL (US)

(73) Assignee: INEEDTHIS, LLC, Venice, FL (US)

(21) Appl. No.: 19/123,584

(22) PCT Filed: Oct. 25, 2023
(86) PCT No.: PCT/US2023/077798

§ 371 Date: Apr. 23, 2025

Related U.S. Application Data
(60) Provisional application No. 63/419,299, filed on Oct. 25, 2022.

(51) Int. Cl. G10D 1/08; G10D 3/06

(52) U.S. Cl. CPC G10D 3/06

(57) ABSTRACT

A universal musical instrument fingerboard with a sinusoidal plane wave pattern along the top surface that resembles ripple waves. The rippleboard is a improvement to existing fingerboard and fretboard designs by retaining beneficial characteristics and including improvements to intonation assistance, playing comfort and ergonomics. The tone of an instrument is improved via the removal of fret noise. The fingerboard is manufactured with simple techniques and is repairable. A rippleboard vastly reduces the complexity of learning and playing string instruments.

### CROSS REFERENCE TO RELATED APPLICATION

The present application is related to and claims priority to U.S. Provisional Patent Application, entitled “Rippleboard universal fingerboard for stringed musical instruments” which was filed on Oct. 25, 2022 and assigned Ser. No. 63/341,299. The U.S. Provisional Patent Application 63/341,299 is hereby incorporated by reference in its entirety.

### FIELD OF INVENTION

The present invention is an improvement to a fingerboard design for bowed musical instruments that utilize a flat planar surface such as violins, violas, cellos, contra basses, and plucked stringed musical instruments that utilizes a fretboard such as guitars, bass guitars, banjos, mandolins, and citterns, particularly focused to the neck and/or fingerboard playing surface of these stringed musical instruments.

### BACKGROUND

Bowed family instruments such as violins, violas, cellos, and contra basses have used flat planar surface fingerboards, with the exception of the cello and contra basses having used gut strands wrapped over a fingerboard as fret pitch guides. A flat planar surface has many benefits sought by musicians of these instrument types such as:
a) providing a larger contact surface area where the string makes contact against the surface of the fingerboard creating a warmer tone.
b) providing clean and smooth shifting from various playing positions without hearing chromatic shifts.
c) providing the ability to adjust the pitch in small microtonal increments.

Not having pitch guides creates a large difficulty in learning, adopting and performing on bowed string instruments.

Plucked family instruments such as guitars, bass guitars, banjos, citterns, mandolins, and ukuleles have primarily used fingerboards with integrated frets named fretboards. A fretboard vastly reduces the complexity of the instrument by providing position guides for finger placement behind a small fret. Fretboards also come with an inherent disadvantage of fret noise produced by long vibrating strings making contact with the small surface area of a fret, and an uncomfortable playing surface when shifting up and down a fretboard by scraping the frets that are usually metallic with your fingers.

### SUMMARY

The present disclosure solves the above needs and deficiencies with known systems for pitch guides. For example, the system disclosed herein may use continuously expanding longitudinal ripples formed on the surface of the rippleboard. The placement and size of the ripples are based on the tuning system and scale length used in the construction of a string instrument.

In an aspect of the system a musical instrument fingerboard is provided including a top surface pattern resembling a ripple wave with each successive wavelength having peak-to-peak amplitude decay. The fingerboard includes a peak of each wave or ripple positioned at a distance based on a music tuning system and a scale length of the musical instrument.

Another aspect of the fingerboard includes peaks of each wave or ripple utilizing a maximum surface area on the fingerboard permitted by each step of the music tuning system and the scale length.

Another aspect of the fingerboard utilizes a single-scale length in the formula for calculating the ripple positions, ripple angles and ripple wavelengths.

### BRIEF DESCRIPTION OF DRAWINGS

FIG. 1 is a representation of a violin waveform;

FIG. 2 is a representation of a ripple wave construction using peak-to-peak amplitude calculations for each wave;

FIG. 3 is a top plan view of a violin;

FIG. 4 is a side plan view of a violin;

FIG. 5 is an isometric view of a violin;

FIG. 6 is a top plan view of a guitar;

FIG. 7 is a side plan view of a guitar;

FIG. 8 is an isometric view of a guitar:

FIG. 9 is an isometric view of a violin rippleboard;

FIG. 10 is an isometric view of a reverse side of a violin rippleboard;

FIG. 11 is an isometric view of a guitar rippleboard;

FIG. 12 is an isometric view of a reverse side of a guitar rippleboard;

FIG. 13 is side plan view of a rippleboard;

FIG. 14 is a side plan view of a violin rippleboard;

FIG. 15 is a cross-sectional view at the saddle end of a violin rippleboard;

FIG. 16 is a cross-sectional view of a violin rippleboard at the nut end;

FIG. 17 is a segmented side plan view of a guitar rippleboard;

FIG. 18 is a side plan view of a guitar rippleboard;

FIG. 19 is a cross-sectional view of a guitar rippleboard with a radiused surface at the saddle end;

FIG. 20 is a cross-sectional view of a guitar rippleboard at the nut end;

FIG. 21 is a cross-sectional view of a guitar rippleboard with a flat top surface;

FIG. 22 is a cross-sectional view of a guitar ripple board with a compound radiused surface; and

FIG. 23 is a representation of a ripple wave construction by setting the start and end depth from the top surface as the wave constraint.

### DETAILED DESCRIPTION

One or more of the embodiments of this invention provide a method or apparatus for a universal musical instrument pitch guide that replaces a fret based “fretboard”, and a non-fret based “fingerboard” with a ripple based “rippleboard.” A ripple based board mimics the appearance of continuously expanding ripples formed on the surface of still water when perturbed at a single point. A ripple based system achieves pitch guides with the widest possible splined ridge radii positioned laterally along an instrument's pitch board by forming, from the nut to the bridge, directionally contracting corrugated sine-wave patterned peaks and troughs wherein each successive wavelength pattern as a shortened peak-to-peak amplitude in proportion to the calculated distance of the previous wave peak.

A ripple based system provides the largest possible surface area for each pitch guide while simultaneously requiring pitch accuracy at the extreme of the radiused peak where a string contacts the surface of the underlying board when depressed by a finger or device. A ripple based system provides greater playing comfort, is simple to manufacture and repair with traditional luthier techniques, and eliminates fret noise produced by thin pitch guide surfaces. Whereas, for non-fretted or non-pitch guided baroque and classical period instruments and their derivatives, a ripple based system is an advancement, reducing the complexity of previously considered difficult instruments without compromising any benefits in existing musical techniques provided by any prior fingerboard or fretboard design.

A rippleboard is built to integrate into a string instrument such as a violin or a guitar. The rippleboard may be constructed of solid wood, a wood composite, or a plastic such as polyethylene or polystyrene. In alternate embodiments wherein the rippleboard may be made of a composite material, including a wood veneer, the composite is laid up one layer on top of another with a layer of resin, glue, or similar in between the veneer until the three-dimensional shape of the rippleboard is created. This construction process can be completed separately from an instrument or it can be completed on a string instrument's traditional neck. If the rippleboard is constructed separately, the rippleboard is later attached to an instrument with glue similar to a sticker, clamps, adhesive or a similar fastener.

In an embodiment of a rippleboard frets, position markers, ghost, flush fret or other indicators are positioned on the peak or the trough. The indicators may be recessed into the rippleboard, glued or otherwise attached to the rippleboard, the indicators are printed on the rippleboard or the indicators are prefabricated and attached to the peak, trough or sides of the rippleboard.

Referring to the figures, three waves of a violin waveform series 1 are shown in FIG. 1. The waveform contains peaks 1a, troughs 1b, a gradual and proportionate decrease in peak-to-peak amplitude 1c throughout the series and a wavelength 1d of a ripple wave.

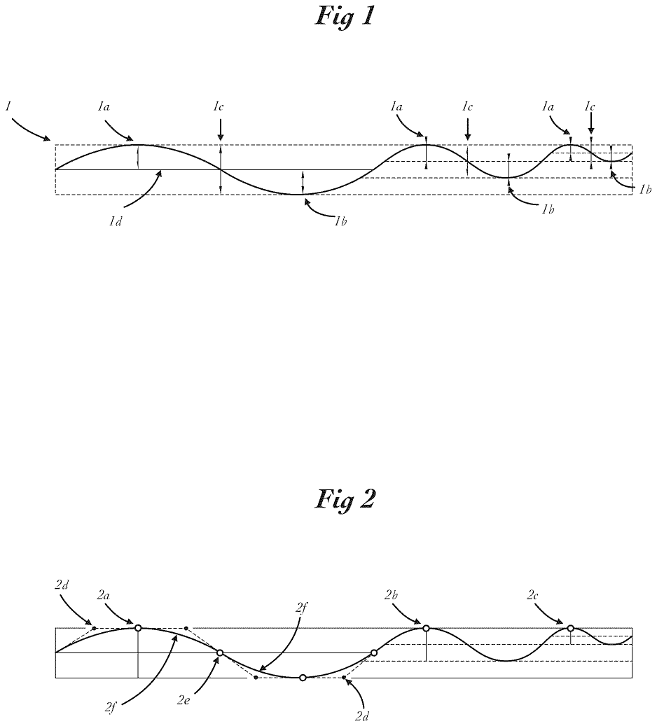

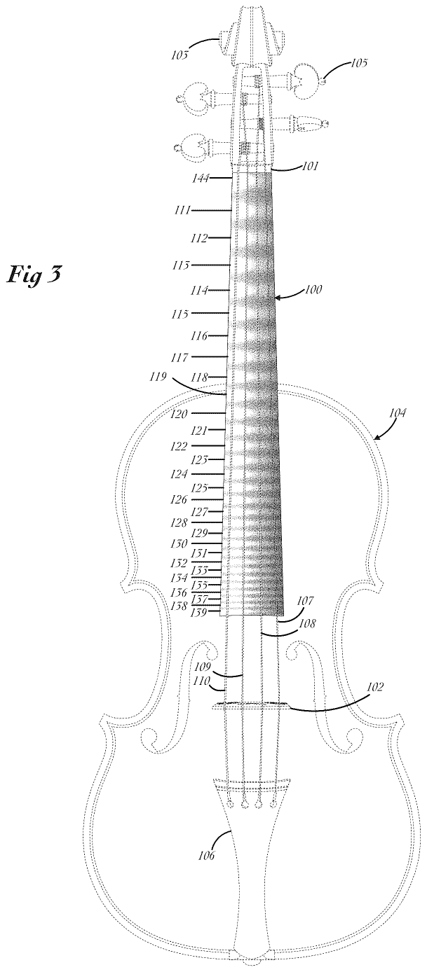

FIG. 2 shows the three waves of a ripple waveform series 2. The waveform contains peaks with each subsequent peak having a reduced peak-to-peak amplitude 2a, 2b, and 2c. In an exemplary embodiment, control points 2d are used for defining splines 2f, and center points 2e utilized to calculate spline centers.

FIG. 23 shows three waves of a ripple waveform series 2. The waveform is defined through the use of a start depth 237 and end depth 240. A virtual top constraint line 241 is used for construction of wave peaks 239 and virtual bottom constraint line 242 is used for construction of ripple troughs 238.

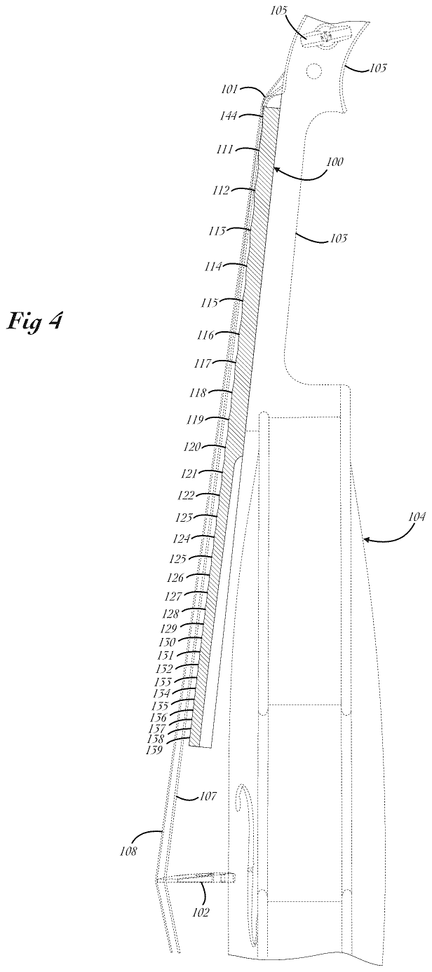

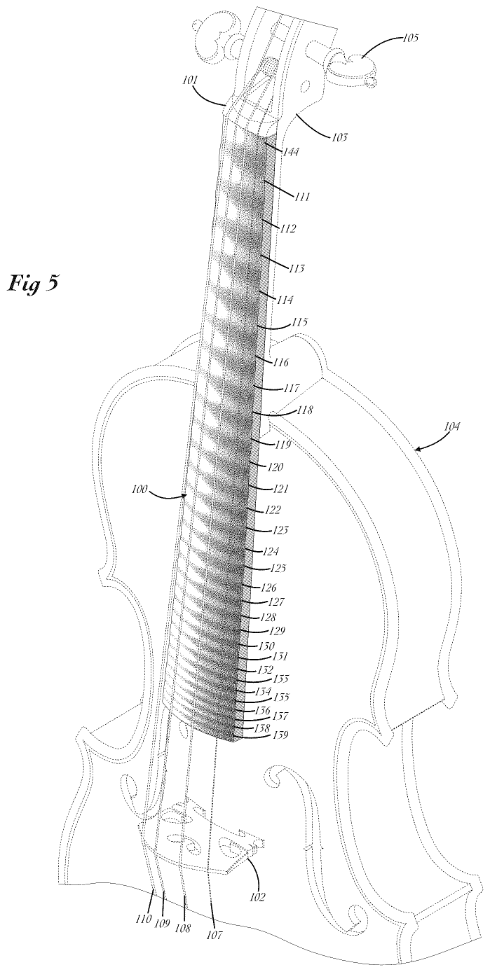

FIGS. 3, 4, and 5 show a violin including the rippleboard. FIG. 3 is a top plan view of a violin. FIG. 4 is a side plan view of a violin. FIG. 5 is an isometric view of a violin. The figures disclose the violin 104 including a neck 103, a rippleboard 100, a scale length calculated by the distance from the nut 101 to a bridge 102, four strings 107-110 attached to the violin from tuning pegs 105 to a tailpiece 106. An attached rippleboard 100 comprised of 29 ripple waves 111-139, and an addition of a half ripple wave 144 where the rippleboard 100 connects with the nut 101.

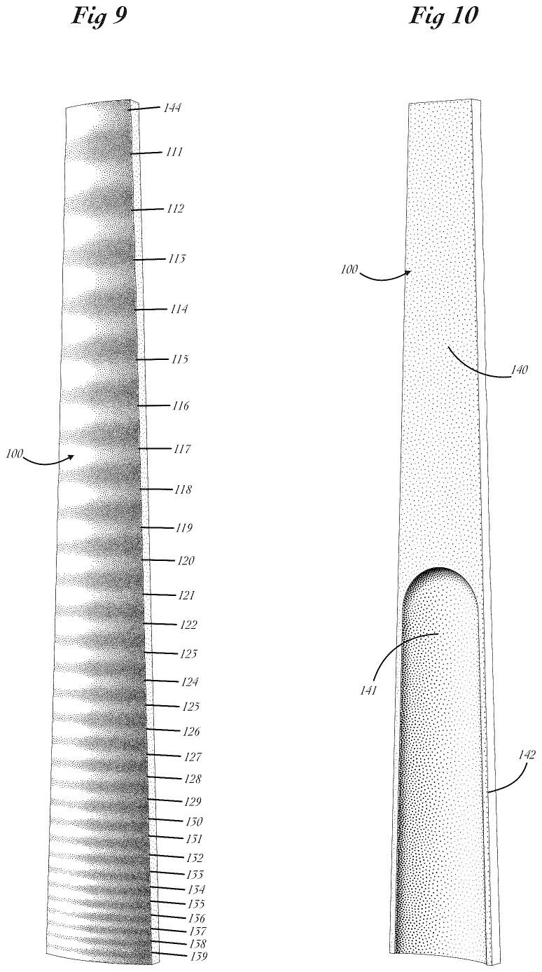

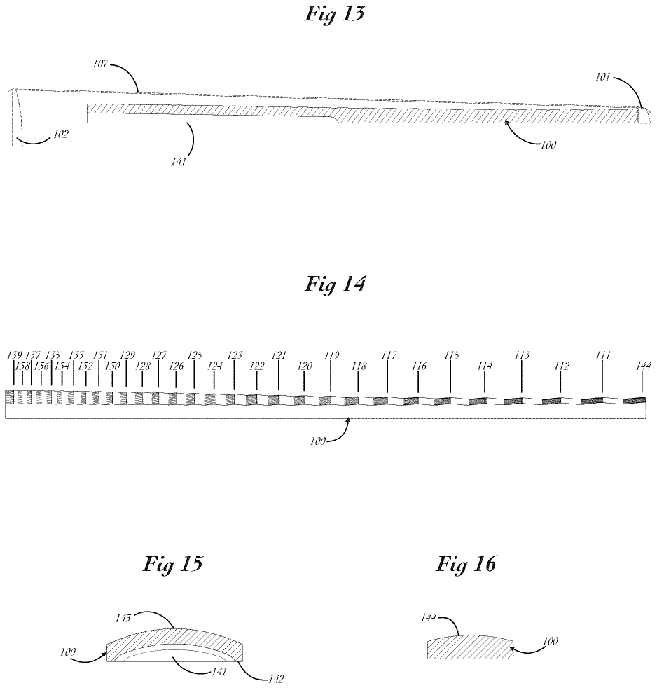

FIGS. 9, 10, 13, 14, 15, and 16 show an exemplary violin rippleboard. FIG. 9 is an isometric view of an individual violin rippleboard. FIG. 10 is an isometric view of the reverse side of a violin rippleboard. The violin rippleboard 100 includes 29 ripples 111-139. The rippleboard may also include a half ripple wave at 144. The reverse side of the violin rippleboard 140 may be glued or similarly attached to a violin. Both embodiments may include a carved underside 141 with thin carved rails 142 is included in the reverse side of the rippleboard. FIG. 13 is a side plan view of a violin rippleboard 100. The scale length of the rippleboard is related to the string 107 length between the nut 101 and the bridge 102. The carved underside 141 is visible in the figure. FIG. 14 is a side plan view of a violin rippleboard 100 with convexity along the length of the board. FIG. 15 is a cross-sectional view of the violin rippleboard 100 with a 41.5 mm top asymmetric contour radius 143. The rippleboard 100 may include an underside carve out 141 which removes weight from the rippleboard 100 and increases tonal response and the side rail 142. FIG. 16 is a cross-sectional view of the violin rippleboard 100 and acts as a cross-section. This view shows the top radius and the height of the half ripple wave 144.

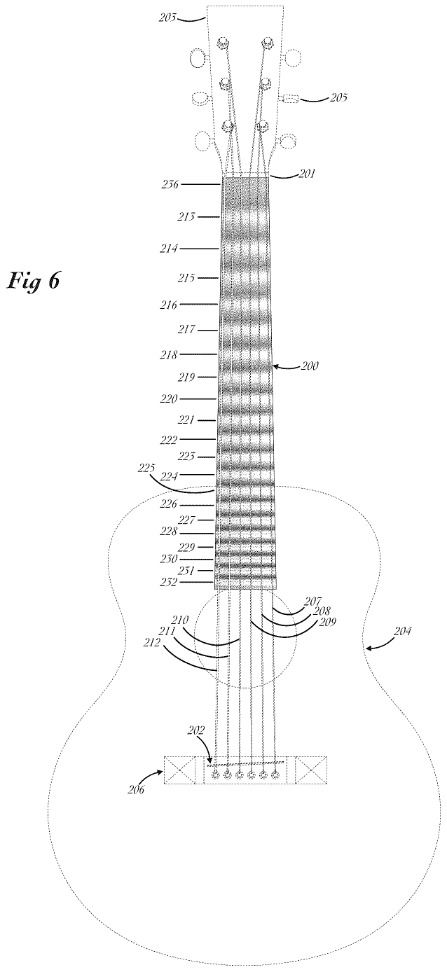

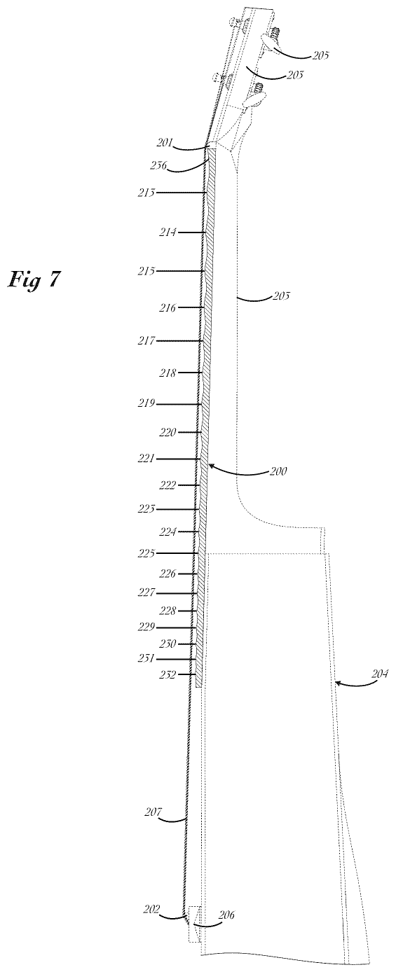

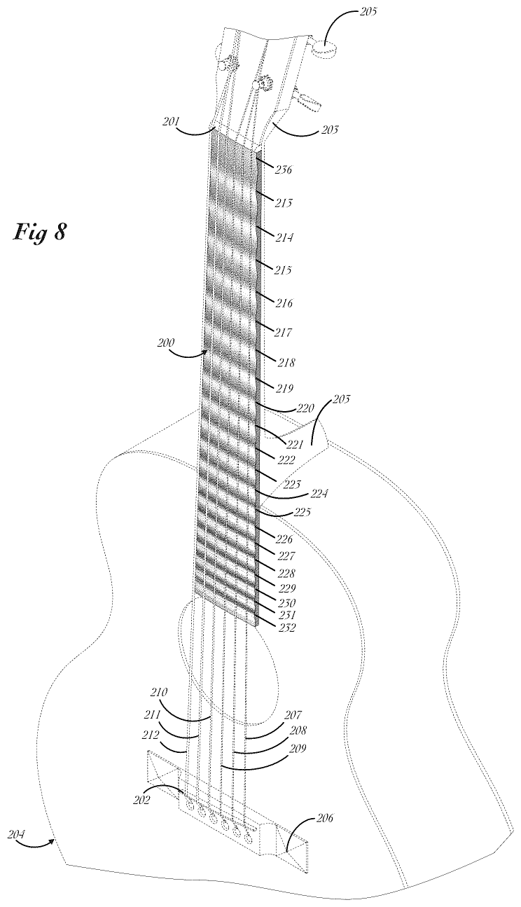

FIGS. 6, 7, and 8 show an exemplary guitar including the rippleboard. FIG. 6 is a top plan view of a guitar. FIG. 7 is a side plan view of a guitar. FIG. 8 is an isometric view of a guitar. The figures disclose the guitar 204 including a neck 203, a rippleboard 200, a scale length calculated by the distance from the nut 201 to a saddle 202, six strings 207-212 attached to the guitar from tuning pegs 205 to a tailpiece 206. An attached rippleboard 200 comprised of 20 ripple waves 213-232, and may include an addition of a half ripple wave 236 where the rippleboard 200 connects with the nut 201.

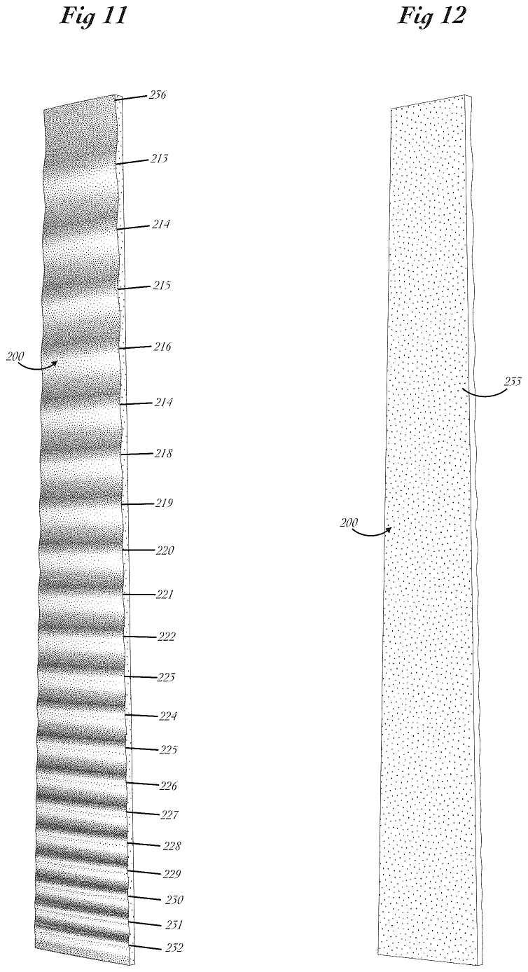

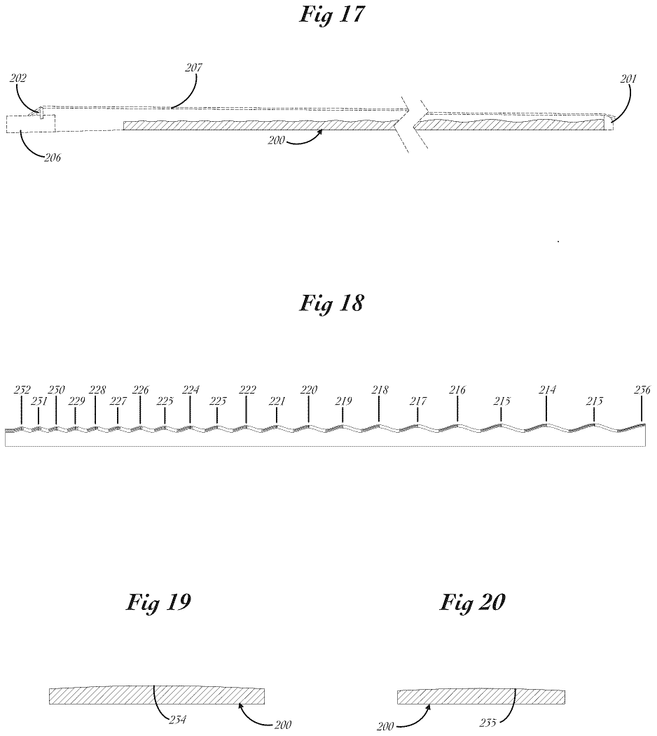

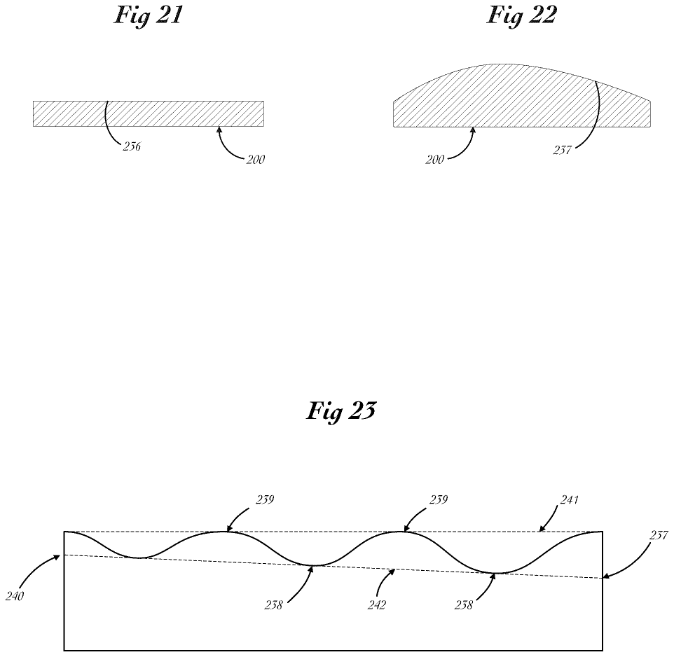

FIGS. 11, 12, 17, 18, 19, and 20 show an exemplary guitar rippleboard. FIG. 11 is an isometric view of an individual guitar rippleboard. FIG. 12 is an isometric view of the reverse side of a guitar rippleboard. The guitar rippleboard 200 includes 20 ripples 213-232. The rippleboard may include a half ripple wave at 236. The reverse side of the guitar rippleboard 233 may be glued or similarly attached to the guitar neck 203. FIG. 17 is a side plan view of a guitar rippleboard 200. The scale length of the rippleboard is related to the string 207 length between the nut 201 and the saddle 202 which sit on the guitar bridge 206. FIG. 18 is a side plan view of a guitar rippleboard 200 with convexity along the width of the board. FIG. 19 is a cross-sectional view of the guitar rippleboard 200 with a 15 inch top contour radius 234 and acts as a cross-section. FIG. 20 is a cross-sectional view of the guitar rippleboard 200. This view shows the top contour radius from the top 235. FIG. 21 is another example of a cross-sectional view of a guitar rippleboard 200 with a flat surface 236, no additional curve and acts as a cross-section. FIG. 22 is another example of a cross-sectional view of a guitar rippleboard 200 and acts as a cross-section. This figure has a compound curve on the surface 237 with multiple radii used to form the curve.

FIGS. 15, 16, 19, 20, 21, 22 show a ripple wave can be applied to all fingerboard shapes used by both fretted and non-fretted instruments. A flat, simple curved surface, horizontally and/or vertically compound curved fingerboard shape. Each of these shapes are utilized by all fretted and non-fretted instruments. A ripple wave pattern can be applied to all of these shapes to not change the form and function of each underlying fingerboard required by each instrument.

In an embodiment the rippleboard accommodates a single scale-equal temperament music tuning system including the 12^{th} rule of 2 or the root of 18. Equal temperament and scale length of an instrument can utilize the following formula to calculate the distance from the nut, the position the string starts, to each ripple peak of the instrument musical tuning system:

d=s−(s/2\hat{ }(r/12))

Wherein d is the distance from the nut; s is the scale length; and r is the number of ripple peaks.

In an exemplary embodiment, the peak-to-peak amplitude for each wave is calculated based on the start amplitude chosen or the end amplitude chosen. The start amplitude is proportional to end amplitude and the distance between each step, dictated by the scale system and scale length chosen and for how the instrument is intended to sound and function. The start amplitude value may be a predetermined value about 0.3 mm and the end value may be a predetermined value about 0.1 mm, changes to the start and end values will affect how the instruments sounds or functions. For example, the average minimum value a human finger can differentiate by touch is 0.1 mm, which is a preferred smallest amplitude for the rippleboard. Using 0.1 mm as exemplary end depth value, as in Table 1, we can calculate the start value and the amplitude decrease proportional back towards the initial start amplitude. Working from a start amplitude we can increase proportionally the peak amplitude of each successive wave based on the increasing distance between steps displayed in Tablel for an exemplary non-fretted instrument (violin) and Table 2 for an exemplary fretted instrument (guitar). Table 2 uses a predetermined value for the start value, but it could also be proportionate to the increase in size from an optimal violin scale length and scale system or a larger guitar sized scale length and scale system of choice.

In FIG. 2 each wave peak 2a, 2b and 2c and trough is comprised of two splines 2f. Each wave is comprised of four of these splines. A spline 2f can alternatively be asymmetrical by placing a spline's one or more control points at random locations thereby creating an asymmetric wave. Referring to FIG. 2, the spline is selected to form a ripple peak and trough to create the maximum surface area of the crown-like ripple peak. To do this, the control points 2d are set at the center distance for the peaks 2a, 2b and 2c and the central amplitude point 2e, and the center of each wave trough. This creates the desired depth in front and behind a ripple wave and creates the largest surface area of the fret crown-like ripple peak. Additionally, the maximum surface area created for a rippleboard is characterized by a wave series wherein the splines that create the wave are equidistant, proportional, and symmetrical.

In an additional embodiment, the rippleboard may accommodate a muli-scale system. The rippleboard may be manufactured to accommodate multiple musical scales. For example, a first scale may be arranged on a left side of the ripple board and a second scale is arranged on the right side of the rippleboard. The peaks and troughs of the rippleboard system are then extended between each scale in a fan like pattern along the length of the rippleboard.

In an exemplary embodiment the rippleboard accommodates a 4/4 (330 mm) scale violin. Peak positions and wavelength amplitudes for a violin with 330 mm single scale length, 29 ripples, a starting peak-to-peak amplitude of 0.51 mm, and common equal temperament music tuning system formula:

TABLE 1

| | | | | | Peak-to-Peak |
|---|---|---|---|---|---|
| Peak | Distance | | Ripple | | Amplitude for |
| # | from Nut | | to Ripple | | Wavelength |
| 1 | 18.521 | mm | 18.521 | mm (Nut-1) | 0.51 mm |
| 2 | 36.003 | mm | 17.482 | mm (1-2) | 0.481 mm |
| 3 | 52.504 | mm | 16.501 | mm (2-3) | 0.454 mm |
| 4 | 68.079 | mm | 15.575 | mm (3-4) | 0.428 mm |
| 5 | 82.779 | mm | 14.701 | mm (4-5) | 0.404 mm |
| 6 | 96.655 | mm | 13.875 | mm (5-6) | 0.382 mm |
| 7 | 109.751 | mm | 13.097 | mm (6-7) | 0.360 mm |
| 8 | 122.113 | mm | 12.362 | mm (7-8) | 0.340 mm |
| 9 | 133.781 | mm | 11.668 | mm (8-9) | 0.321 mm |
| 10 | 144.794 | mm | 11.013 | mm (9-10) | 0.303 mm |
| 11 | 155.189 | mm | 10.395 | mm (10-11) | 0.286 mm |
| 12 | 165.000 | mm | 9.811 | mm (11-12) | 0.270 mm |
| 13 | 174.261 | mm | 9.261 | mm (12-13) | 0.255 mm |
| 14 | 183.002 | mm | 8.741 | mm (13-14) | 0.240 mm |
| 15 | 191.252 | mm | 8.250 | mm (14-15) | 0.227 mm |
| 16 | 199.039 | mm | 7.787 | mm (15-16) | 0.214 mm |
| 17 | 206.390 | mm | 7.350 | mm (16-17) | 0.202 mm |
| 18 | 213.327 | mm | 6.938 | mm (17-18) | 0.191 mm |
| 19 | 219.876 | mm | 6.548 | mm (18-19) | 0.180 mm |
| 20 | 226.057 | mm | 6.181 | mm (19-20) | 0.170 mm |
| 21 | 231.890 | mm | 5.834 | mm (20-21) | 0.160 mm |
| 22 | 237.397 | mm | 5.506 | mm (21-22) | 0.151 mm |
| 23 | 242.594 | mm | 5.197 | mm (22-23) | 0.143 mm |
| 24 | 247.500 | mm | 4.906 | mm (23-24) | 0.135 mm |
| 25 | 252.130 | mm | 4.630 | mm (24-25) | 0.127 mm |
| 26 | 256.501 | mm | 4.370 | mm (25-26) | 0.120 mm |
| 27 | 260.626 | mm | 4.125 | mm (26-27) | 0.113 mm |
| 28 | 264.520 | mm | 3.894 | mm (27-28) | 0.107 mm |
| 29 | 268.195 | mm | 3.675 | mm (28-29) | 0.101 mm |

In an exemplary embodiment the rippleboard accommodates a 643.636 mm (25.34″) scale guitar. Peak positions and wavelength amplitudes for a guitar with a 25.34″ single scale length, 20 ripples, a starting peak-to-peak amplitude of 1.5 mm, and equal temperament music tuning system formula:

TABLE 2

| | | | | | Peak-to-Peak |
|---|---|---|---|---|---|
| Ripple | Distance | | Ripple | | Amplitude for |
| # | from Nut | | to Ripple | | Wavelength |
| 1 | 36.125 | mm | 36.125 | mm (nut-1) | 1.5 mm |
| 2 | 70.222 | mm | 34.097 | mm (1-2) | 1.145 mm |
| 3 | 102.405 | mm | 32.183 | mm (2-3) | 1.336 mm |
| 4 | 132.782 | mm | 30.377 | mm (3-4) | 1.261 mm |
| 5 | 161.454 | mm | 28.672 | mm (4-5) | 1.190 mm |
| 6 | 188.517 | mm | 27.063 | mm (5-6) | 1.123 mm |
| 7 | 214.061 | mm | 25.544 | mm (6-7) | 1.060 mm |
| 8 | 238.171 | mm | 24.110 | mm (7-8) | 1.000 mm |
| 9 | 260.928 | mm | 22.757 | mm (8-9) | 0.944 mm |
| 10 | 282.408 | mm | 21.480 | mm (9-10) | 0.891 mm |
| 11 | 302.682 | mm | 20.274 | mm (10-11) | 0.841 mm |
| 12 | 321.818 | mm | 19.136 | mm (11-12) | 0.794 mm |
| 13 | 339.880 | mm | 18.062 | mm (12-13) | 0.749 mm |
| 14 | 356.929 | mm | 17.048 | mm (13-14) | 0.707 mm |
| 15 | 373.020 | mm | 16.092 | mm (14-15) | 0.668 mm |
| 16 | 388.209 | mm | 15.188 | mm (15-16) | 0.630 mm |
| 17 | 402.545 | mm | 14.336 | mm (16-17) | 0.595 mm |
| 18 | 416.076 | mm | 13.531 | mm (17-18) | 0.561 mm |
| 19 | 428.848 | mm | 12.772 | mm (18-19) | 0.530 mm |
| 20 | 440.903 | mm | 12.055 | mm (19-20) | 0.500 mm |

In an exemplary embodiment as illustrated by FIG. 23, a ripple wave is calculated by defining a depth point at the start of the scale 237 and a depth point at the end of the scale 240. In Table 1 the smallest depth point used at the end of the scale for ripple 29-30 is 0.101 mm. Using a proportional fraction calculation, we can determine the start value for ripple 0-1 to be 0.51 mm in Table 1 since the distance for ripple 0-1 and ripple 29-30 is determined by the scale system and scale length calculation. In FIG. 23, after deciding on our initial start or end value, a virtual line is drawn from the start depth point 237 and end depth point 240. The depth points are defined as distances from the top surface. This permits the ripple wave design to accommodate a flat board, a simple curved board, a horizontally compound curved board, a vertically compound curved board, and both horizontal and vertical compound curved boards. The top virtual line 241 functions as the constraint for the ripple peaks, it can be flat, curved, or compound curved. The middle virtual line 242 is determined from the depth points 237 to 240. The ripple wave is then constrained by the top virtual line 241 and the middle virtual line 242 created by the depth points 237 and 240. The splines 2f that create each wave can be symmetric, equidistant, and proportional as shown in the example figures. Depending on the instrument and intent of sound and function, splines 2f that form the waves can also be asymmetric or skewed to form additional wave patterns that do not affect the peak positioning of the wave yet alter the visual appearance of the wave pattern, while simultaneously maintaining the decrease in amplitude as the wave shortens higher in the scale as the distance between steps decreases.

In an exemplary embodiment, the maximum surface area on a ripple board refers to the surface area defined by the width of the neck and the longitudinal width of the individual ripple. Instead of using a thin “fret” with a rounded top (aka “fret crown”) the rippleboard uses wide wave peaks. A fret is commonly 0.75-2 mm with a round “crown” formed on the top at the required position set by the scale length and system utilized. A large vibrating string contacting a small thin surface of a thin fret-like surface produces an inherent fret noise from the harmonics generated by the large vibrating surface contacting a thin “small surface area” of the fret. Maximizing the surface area or width of the fret-like crown by using proportional and centered ripple peaks thus eliminates much of this inherent fret noise caused by prior fret designs. It also creates the ability to play on top of the ripple peak and behind the ripple peak with varying pressures to chromatically change the pitch inherent to non-fretted designs. Likewise, by utilizing a ripple wave the troughs remain as shallow as possible while remaining proportionate to the ripple peaks thus preventing string stretch caused by pressure behind a fret causing the fret pitches to be out of tune when pressed too hard. On a ripple board the depth being even and centered between each peak and trough thus prevents the pitch slip while providing the ability to play the entire chromatic spectrum evenly throughout a scale. A Rippleboard ripple wave provides the benefits found in both fretted and non-fretted instrument designs and thus giving both instrument type the benefits inherent with both prior designs.

It should be understood that this description (including the figures) is only representative of some illustrative embodiments. For the convenience of the reader, the above description has focused on representative samples of all possible embodiments, and samples that teach the principles of the disclosure. The description has not attempted to exhaustively enumerate all possible variations. That alternate embodiments may not have been presented for a specific portion of the disclosure, or that further undescribed alternate embodiments may be available for a portion, is not to be considered a disclaimer of those alternate embodiments. One of ordinary skill will appreciate that many of those undescribed embodiments incorporate the same principles of the disclosure as claimed and others are equivalent.

I claim:

1. A musical instrument fingerboard comprising:
a top surface pattern forming a wave having a plurality of peaks and troughs with each successive wavelength has decaying peak-to-peak amplitude; and
a peak of each wave is positioned at a distance from the nut based on a music tuning system and a scale length of the musical instrument.

2. The fingerboard as described in claim 1, with peaks utilizing a maximum surface area on the fingerboard permitted by each step of the music tuning system and the scale length.

3. The fingerboard described in claim 1, wherein the rippleboard is a solid unit affixed to an instrument.

4. The fingerboard described in claim 1, wherein the rippleboard is a hollow unit affixed to an instrument.

5. The fingerboard described in claim 1, wherein the rippleboard is a single unit integrated with the neck of the instrument.

6. The fingerboard described in claim 1, wherein the rippleboard is a veneer including ripple waves and applied to the top surface of an existing rigid musical instrument fingerboard.

7. The fingerboard described in claim 1, constructed as a veneer applied to the top surface of an instrument's traditional neck.

8. The fingerboard described in claim 1, utilizing a single-scale length for calculating the ripple positions, ripple angles and ripple wavelengths.

9. The fingerboard described in claim 1, utilizing a multi-scale length for calculating the ripple positions, ripple angles and ripple wavelengths.

10. The fingerboard described in claim 1, wherein the rippleboard has at least one of a flat, radiused, or compound radiused top surface across the cross-sectional width.

11. The fingerboard described in claim 1, wherein each peak maintains the same top peak height relative to the bottom of the rippleboard.

12. The fingerboard in claim 1, having ripples with peak-to-peak amplitude decay for each successive wavelength in the series.

13. The fingerboard in claim 1, using a rule of 18 as the musical tuning system.

14. The fingerboard in claim 1, using a 12th root of 2 as the musical tuning system.

15. The fingerboard described in claim 1, with positional visual location markers on at least one of the top or sides, and including at least one of cavities, inlays, stickers, drawn upon, and/or veneers.

16. A rippleboard comprising a series of peaks and troughs fabricated along a vertical length of the rippleboard in a wave pattern and the rippleboard is configured to be received by a traditional neck of a string instrument.

17. The rippleboard described in claim 16, wherein a height and width of each peak and trough is determined by a combination of a distance along the length of the rippleboard of the peak or trough from a tuning peg of the instrument and the musical scale the instrument is tuned to.

18. The rippleboard of claim 17, wherein a horizontal cross-section of the rippleboard is at least one of a flat, radiused, or compound radiused top surface across the cross-sectional width.

19. The rippleboard of claim 17, wherein the wave is symmetrical, proportional and equidistant and;
the height and width of each peak and trough decreases starting at a head and reaching the smallest peak near a body of the instrument.

20. The rippleboard of claim 17, wherein at least one of cavities, inlays, stickers, drawn upon, or veneers are integrated into a top surface of the rippleboard.
